(19) United States
(12) Patent Application Publication
(10) Pub. No.: US 2017/0118357 A1
(43) Pub. Date: Apr. 27, 2017

(54) METHODS AND SYSTEMS FOR AUTOMATIC CUSTOMIZATION OF PRINTED SURFACES WITH DIGITAL IMAGES

(71) Applicant: Foldables LLC, Roseville, MN (US)

(72) Inventor: Joel Orrie Morris, Roseville, MN (US)

(21) Appl. No.: 15/332,024

(22) Filed: Oct. 24, 2016

Related U.S. Application Data
(60) Provisional application No. 62/395,356, filed on Sep. 15, 2016.
(60) Provisional application No. 62/246,738, filed on Oct. 27, 2015.

(51) Int. Cl. H04N 1/00; H04N 1/387; H04N 1/393; G06K 9/00

(52) U.S. Cl. CPC H04N 1/00167; G06K 9/00281; H04N 1/3877; H04N 1/393; H04N 1/00164; H04N 1/00177; H04N 1/0019; H04N 1/00196

(57) ABSTRACT

Methods and systems for incorporating an image of a person or a portion of a person from a digital image into a target space for printing on a surface. The method may include receiving a selected digital image from a user, identifying a set of specific body features in the digital image, modifying the digital image to align locations of the body features in the digital image with corresponding target locations in the target space, and sending a representation of the modified digital image of the person or portion of the person within the target space to the user. The portion of the image may be a face of a person, and the target space may be the face portion of a figure which may be a figure configured for printing onto a sheet for creation of a folded figure.

### BACKGROUND

Digital images are in standard use in current photography. Such images can be easily printed, transmitted electronically, analyzed and modified using various types of software. There are, therefore, many creative new ways in which digital images may be used. For example, it is possible to upload digital photographs and use them to create new things which incorporate the digital image. For example, photographs may be uploaded to services that create cards such as holiday cards. The user can interact with the card making company via a website, creating a personalized card which the user can see and modify in virtual form on the computer prior to ordering copies of the cards. Similarly, a user can create photo albums online by uploading images and inserting them into virtual albums. These albums may be for viewing on line by the user or by others, or may be printed as physical albums in accordance with the user's selections. However, automated processes of using digital images in various ways may be less than satisfactory.

### SUMMARY

Various embodiments include methods and systems for automatically and/or manually incorporating an image of a person, or a portion of a person such as a person's face, from a digital image into a target space for printing on a surface.

In some embodiments, the method includes incorporating an image of a person or a portion of a person from a digital image into a target space for printing on a surface including receiving a selected digital image from a user, automatically identifying a set of specific body features in the digital image, modifying the digital image to align locations of the body features in the digital image with corresponding target locations in the target space, and sending a representation of the modified digital image of the person or portion of the person within the target space to the user such as to a user's display screen. If one or more of the body features of the set cannot be automatically identified, the method may further include sending a request to the user to identify the location in the digital image of the one or more body features of the set which could not be automatically identified, and receiving the location of the one of more body features identified by the user. The step of modifying the digital image may include modifying the portion of the digital image which is the image of the person or the portion of the person by performing one or more of the following steps: scaling by stretching or shrinking, cropping, and/or rotating. In some cases, the step of modifying may include all of these. The modifications may result in the image of the person or portion of the person being configured to fit within, and aligned within, the target space when printed.

In some embodiments, the body features used by the method include 3 facial features. These facial features comprises may include the two eyes and mouth of a person captured in the digital image. In some embodiments, the target space includes a face portion of a figure.

In some embodiments, the method further includes printing the modified image of the person or portion of the person on the surface in the target space. For example, the image of the person or portion of the person may be a face portion, and the method may include printing a body portion of a figure, wherein the face portion in the target space forms the face of the figure.

In some embodiments, a method of incorporating a face portion of a digital image into a target space for printing on a surface includes receiving a selected digital image from a user, automatically identifying a set of specific facial features in the digital image, modifying the digital image to align locations of the facial features of the digital image with corresponding target locations in the target space, and sending a virtual image of the face portion of the modified digital image within the target space to the user. The method may further include sending a digital file of the face portion of the modified digital image within the target space to a user for the user to print and/or may include sending the digital file to a printer to print a physical copy of the face portion the in the target space and sending the printed physical copy of the face portion in the target space to an address provided by a user.

In various embodiments, the method may also include receiving a color selection for an aspect of the figure from the user and the virtual image may include the selected color displayed as an aspect of the figure. For example, the selected color may include a skin color, and the method may further include providing a graphical user interface including an array of skin colors enabling the user to select the skin color. As another example, the selected color may include a color of clothing on the figure, and the method may further include providing a graphical user interface including an array of colors enabling the user to select the clothing color.

In some embodiments, a method of creating a folded figure incorporating an image of a person or a portion of a person from a digital image into a target space on the figure includes receiving a selected digital image from a user, displaying a virtual representation of the image of the person or the portion of the person in a target space of the figure, receiving input from the user modifying the digital image in the target space, and displaying a representation of the modified digital image in the target space of the figure. These steps of receiving and displaying modifications may be repeated until a desired modified image of a person or portion of a person is displayed within the target space. For example, the steps of modifying the digital image may include one or more of aligning the image of the person or portion of the person with the target space, rotating the digital image, or stretching or shrinking the digital image, which may be performed manually by the user by interacting with the virtual image on the user's screen. The method may further include sending a digital file of the modified digital image within the target space to the user or to a printer to print a physical copy of the figure on a foldable sheet and may further include sending the printed physical copy of the figure to an address provided by a user.

### BRIEF DESCRIPTION OF THE DRAWINGS

The following drawings are illustrative of particular embodiments and do not limit the scope of the inventions. The drawings are not necessarily to scale and are intended for use in conjunction with the following detailed description. Embodiments of the inventions will be described with reference to the drawings, in which like numerals may represent like elements.

FIG. 1 is block diagram of an example of a system for facial image modification and reproduction according to various embodiments.

FIG. 2 is a flow chart of the process of creating a customized target space including the face of an individual extracted from a digital image.

FIG. 3 is an example of a graphical user interface for a user to manually identify the locations of facial features in a digital image.

FIG. 4 is a representation of a process of aligning the facial features of a digital image with target locations in a target space and displaying a virtual representation of the face in the face portion of a figure.

FIG. 5 is an example of a surface having a face portion of a digital image extracted and printed in a target space.

FIG. 6 is an example of a three dimensional folded figure having a face portion of a digital image incorporated as the face of the figure.

FIG. 7 is a representation of a process of aligning the facial features of a digital image with target locations in a target space and creating a cartoon version of the digital image.

### DETAILED DESCRIPTION

The following detailed description is exemplary in nature and is not intended to limit the scope, applicability, or configuration of the inventions. Rather, the following description provides practical illustrations for implementing various exemplary embodiments. Utilizing the teachings provided herein, those skilled in the art may recognize that many of the examples have suitable alternatives that may be utilized. This application claims priority to U.S. Provisional application No. 62/246,738, filed Oct. 27, 2015 and entitled A System for Making Paper or Card Stock Toys or Novelty Items with Custom Portrait Images, and to U. S. Provisional application No. 62/395,356, filed Sep. 15, 2016 and entitled Methods and Systems for Automatic Customization of Printed Surfaces with Digital Images, both of which are hereby incorporated by reference.

Various embodiments include methods and systems for extracting the digital image of an individual person, or of a portion of the individual such as a face, from a digital image and incorporating the image of the individual person or portion of the individual (or a representation of the individual or portion of an individual) onto a target space. The person's image or partial image may be automatically identified within the digital image, extracted from the photograph and aligned with the target space. In some embodiments the person's image or partial image may be automatically converted into a representation such as a cartoon. For example the cartoon may be a cartoon of a partial image such as a face. The alignment of the person's image or partial image, such as the face portion, whether the actual digital image or the representation, may be performed by identifying a set of specific body features, such as facial features, in the digital image and adjusting the image so that the body features align with corresponding target locations within the target space. This identification of the body features may be automatic by the system and/or may be performed by a user. The person's image or partial image within the digital image may be modified in order to align the identified body features with the target locations. For example, the person's image or partial image may be increased or decreased in scale and/or rotated and/or stretched or compressed/shrunk as needed to align the person's image or partial image with the corresponding target locations and to fit it within the target space. Alternatively, the entire digital image, or a portion of the image which may be selected by the user, may be manually aligned with the target space by the user. For example, the user may align the image with the target space using a virtual representation on the user's screen and may adjust the image by stretching or shrinking/compressing, rotating, shifting, cropping, and/or scaling the image as desired. This may be done by clicking on the corner of the image as presented on the screen to control the manipulation. In this way, the user may align the image in the target space as desired.

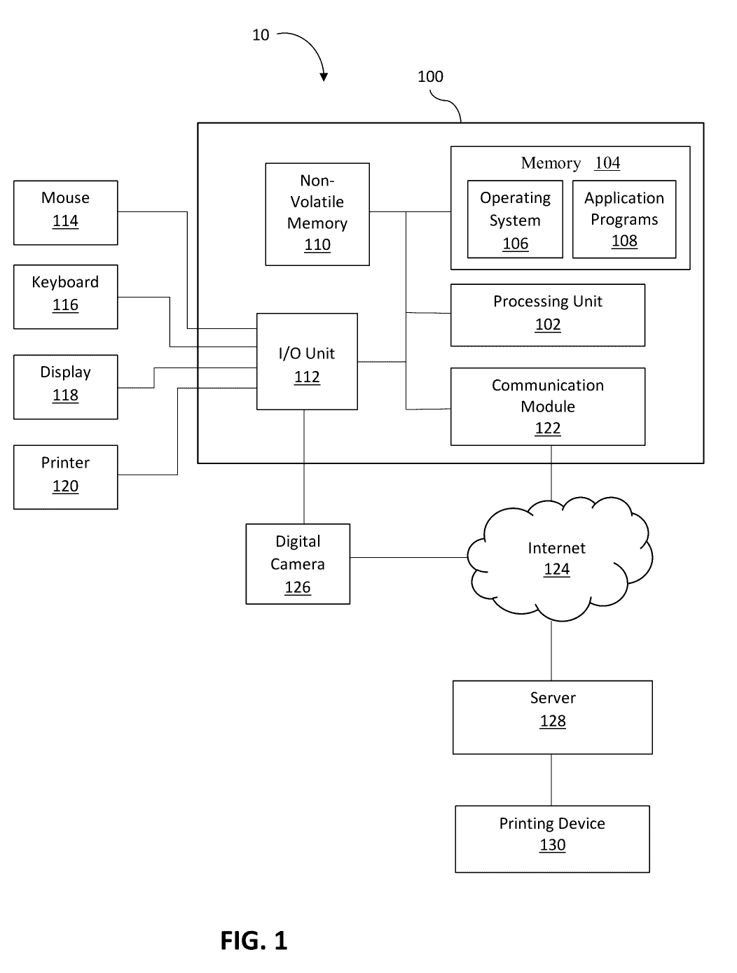

The methods described herein may be performed by a system which may include a personal computing device and a server connected to each other by the internet. An example of such a system 10 is shown in FIG. 1. The system 10 includes a computer 100 which includes a processing unit 102, such as a CPU, and memory 104 that stores data and various programs such as an operating system 106 and one or more application programs 108. The computer 100 further includes non-volatile memory 110 such as a hard drive, removable magnetic disk, removable optical disk, magnetic cassette, flash memory card, random access memories, and/or the others. The computer 100 further includes an input/output (I/O) unit 112 which may be connected to various I/O devices such as a mouse 114, keyboard 116, display 118 such as a computer screen, and printer 120. The connection to these I/O devices may be wired or wireless. The computer 100 further includes a communication module 122 for connecting to the internet 124.

The system 10 may further include a digital camera 126, which may upload digital images to the computer 100 for storage in the non-volatile memory 110 and/or the computer 110 or the camera may upload the digital images to the internet 124 for storage outside the computer 100, such as cloud storage or on the server 128. The digital camera 122 may connect directly to the computer 100 through a wired or wireless connection through the I/O unit 112 or may connect to the computer through the internet 124. It should be noted the digital camera 126 may be any device capable of capturing a digital image, including a traditional camera, a digital video camera, a mobile telephone, a computer, or other similar device. In other embodiments, the source of the digital image may alternatively be a camera included in the computer 100 itself, or a scanner which created a digital image by scanning a physical image such as a traditional film photograph or other printed image, or the image may be created elsewhere and delivered to the computer 100 on a storage medium or via the internet or other communication network.

As shown in FIG. 1, the computer 100 communicates with a server 128 via the internet. The server 128 may be a server of a service provider and may include some or all of the same components as the computer 100. The server 128 may be a single server or multiple servers. The server 128 may include the image extraction and modification service programming thereon, such that the computer 100 may invoke the service via the internet 124, such as by way of an in-browser application or by way of an application. Alternatively, the image extraction and modification programming may be a program stored within the computer 100 itself. As such, the methods described herein as being performed by the system may be performed by software stored on the computer 100, the server 128, or both, and a user may interact with the system using a personal computing device (personal computer, tablet, smart phone, etc.) via an interactive website, for example.

The system may further include a printing service 130 connected to the server 128. The printing service 130 may print the final form of the extracted and modified person's image or partial image, as generated by the system 10, onto a surface in a target space. The printing service 130 may be a standard printer in direct communication with the server 128, via a wired or wireless connection. Alternatively, the server 128 may communicate the printing instructions, including the extracted and modified person's image or partial image, to the printing service 130 by other means such as through the internet 124 or by a transported data storage medium. In still other embodiments, the server 128 may send a printable file to the computer 100 for the user to print the extracted and modified face portion on a surface using the user's own printer 120.

Although the system as described and shown in FIG. 1 is described as including a computer 100, it should be understood that the computer 100 may be a traditional personal computer or laptop or may be an alternative computing device such as a mobile computing device like a smartphone, tablet, or similar device.

Digital images of various types that include a face of a person may be used. The images may be in any digital format such as JPEG, TIF, PNG, GIF, or other digital format.

The person's image may include the entire body including the legs and feet, torso, arms and hands, head and neck, as well as any clothing covering the body, of an individual present in a digital image. If the individual is shown on profile, the person's image may include only the right arm and leg or only the left arm and leg, for use in a target space depicting a person on profile. The portions of the digital image surrounding the person's image may be excluded from the person's image, though in some embodiments and/or in some images a minimal amount of the digital image surrounding the person's body may be included in the person's image, such as a thin margin around the person. In embodiments in which a portion of the person's image is used, the partial image may be any portion of the body such as only the face, only the head, only the head and neck, only the upper torso and arms and head, etc., and the background and other portions of the image may be excluded. Any partial image may be used to correspond with the target space.

In some embodiments, the partial image is a face portion. In such embodiments, the face portion of the digital image includes the facial features of an individual present in the digital image. In some embodiments, the face portion may include the entire head, while in other embodiments it may include only a portion of the head. For example, the face portion may include only the eyes, nose, mouth, and surrounding areas of the face but may not include the hair. In some embodiments, the face portion may extend up to the hair line, or the approximate location of the hair line, to substantially exclude hair. The face portion may extend up to the hair line and/or edge of the chin, or may further include a portion or all of the hair and/or neck of the individual.

When a partial image is used, the portions of the person's image included in the partial image may be set by rules depending upon the target space. For example, in embodiments which use a face portion, the portions of the individual's face and head, and the boundaries of the face portion, may be set by rules which are determined based how the face portion is used in the target space. That is, the face portion may be selected to include specific elements, and exclude others, depending upon the nature of the target space into which it will be inserted. Likewise the face portion may be a view of the face from directly ahead, may be a profile view, or may be a partial profile view, again depending upon the nature of the target space. A particular face view may be used with a particular target space. For example, if the target space is a face component of a figure, and the figure is in a front facing view, then a front facing facial image may be used in that space but not other face views. That is, the view of the face may match the orientation of any figure or other structure with which it is used. The system may direct a user to select an image including the appropriate view of the face and/or it may analyze the image to detect a face having the appropriate view for the target space with which it is used.

The person's image or partial image may ultimately be printed onto a surface in a target space. The surface may be a flat sheet made of a material such paper, plastic, cardboard, metal, wood, polystyrene foam, etc. Alternatively the surface may have a three dimensional shape. For example, the target space may curved, such as a portion of a cylinder or sphere. When the person's image or partial image is printed in the target space, it may fill the target space completely or substantially completely in some embodiments. In other embodiments, the person's image or partial image may not completely fill the target space.

In some embodiments, the surface may include other features which may be printed or otherwise applied thereon, in addition to the target space including the person's image or partial image. For example, when a partial image is a face portion printed in the target space, the additional features may include a body of a figure, such as a human or humanoid figure, which may be printed or otherwise applied to the surface, either simultaneously with printing the face portion in the target space or at a different time. The figure may include a torso, appendages such as arms and/or legs, feet, hands, and/or clothing. In some embodiments, the figure may include hair and/or a hat adjacent to the target space. The target space including the face portion of the image may form the face of the figure, such that the face portion of the image may be printed onto the surface in the target space to customize the figure with the face of the individual in the digital image. In alternative embodiments, the face portion may be inserted into a target space which is not the location of a face of a human or humanoid figure but rather is a predefined space on a different object. For example, the target space may be the face location of an animal figure.

In some embodiments, the target space may be a location on a surface of a foldable object such as a human, humanoid, or animal shaped figure, which may be constructed of a sheet of material such as paper and which may optionally have rotating appendages. In other embodiments, the foldable object may be an inanimate object such as a model of a television set, a building, or a picture in a frame. Examples of such foldable figures which may be used in various embodiments are described in U.S. Pat. No. 9,339,735, entitled Three Dimensional Folded Figures with Rotating Joints, the disclosure of which is hereby incorporated by reference. In other examples the target location may be a location on a surface of a solid inanimate object such as a doll, toy animal, key chain, mug, or other novelty item. In any case, the target space may be configured to receive a person's image or a partial image.

As described above, the target space is the space on the surface in which the person's image or partial image is intended to be printed or otherwise applied. The target space may be any shape, depending up the use and other features of the surface. For example, it may be square, rectangular, triangular, round, oval, or any other shape. Regardless of the shape of the target space, the system is configured to modify the person's image or image portion to fit into the space in a predetermined appropriate alignment.

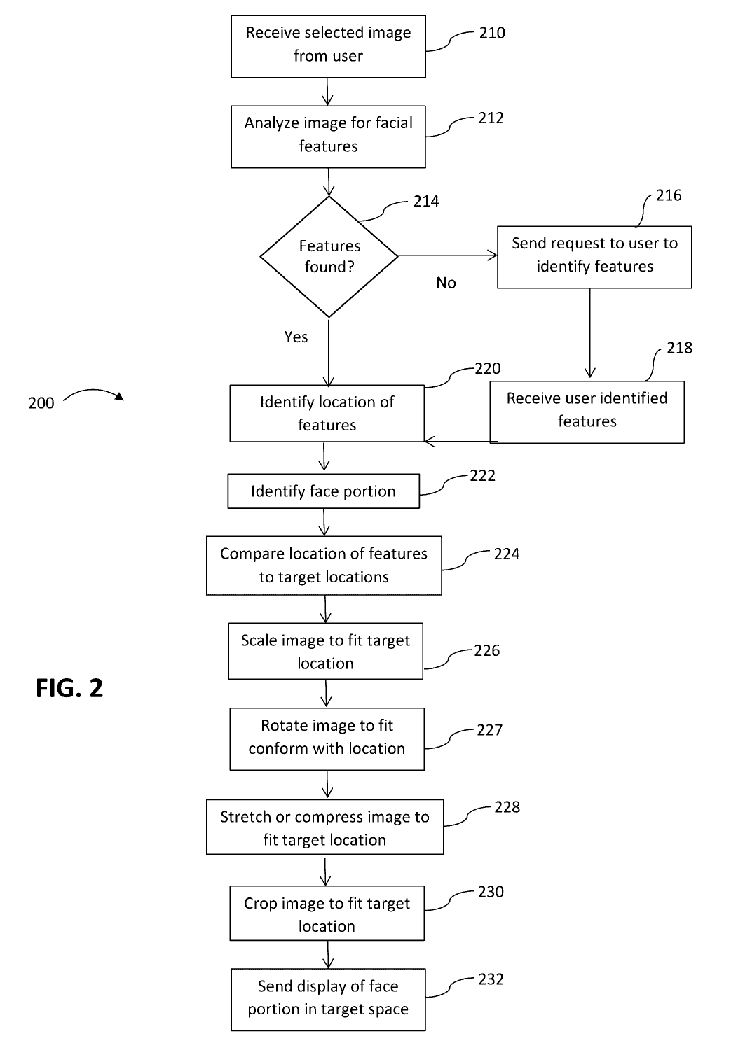

An example of a process of creating a customized target space including a partial image which is the face of an individual pictured in a digital image is shown in the block diagram presented in FIG. 2. The process 200 may begin when a user selects a digital image of an individual and submits it to the system. The system receives the selected image from the user in step 210. For example, a user may select a digital image by uploading it from the memory of a computer or mobile device, or select a digital image from a library of available images that may have been previously uploaded onto the system. In some embodiments, the system may instruct the user with regard to the correct type of digital image to select for a particular use, such as instructing the user to select a photo including only a single individual or specifying the orientation of individual's face (e.g. directly facing the camera or on profile, for example).

Next, the system may analyze the image to automatically identify a set of specific facial features in step 212, such as one, two, three or more facial features. The particular facial features used in a given embodiment may depend upon the type of facial view used with a particular target space. This process may be performed using commercially available facial recognition software or similar software. In alternative embodiments, such as embodiments incorporating a person's image or partial image of a different part of the body, a set of other specific body features which may or may not include the facial features, may be used in this step and in the steps that follow relating to the facial features.

Depending upon the image and the software, in some cases the system may not be able to identify some or all of the facial features of the set in the selected image. For example, the features may be difficult for the system to recognize, or the image may include more than one face, preventing automatic detection of the facial features by the system. At step 214, the system may proceed differently, depending upon whether all of the facial features of the set are automatically identified. If the system is not able to identify some or all of the facial features of the set, such as one, two, or three of the facial features, the process may proceed to step 216 in which the system sends the user a request to identify the facial features.

In step 216, the system may display the selected image on the user's screen as a graphical user interface (GUI) with instructions for the user to mark the specific facial features. The instructions may proceed consecutively (or all features could be requested at one time) one at a time through each of the facial features of the set, or each of the features of the set which the system was not able to automatically identify, progressing from a first to a second to a third facial feature, etc., as the user marks the location of each feature. Alternatively, the instructions to identify facial features could all be presented to a user at one time.

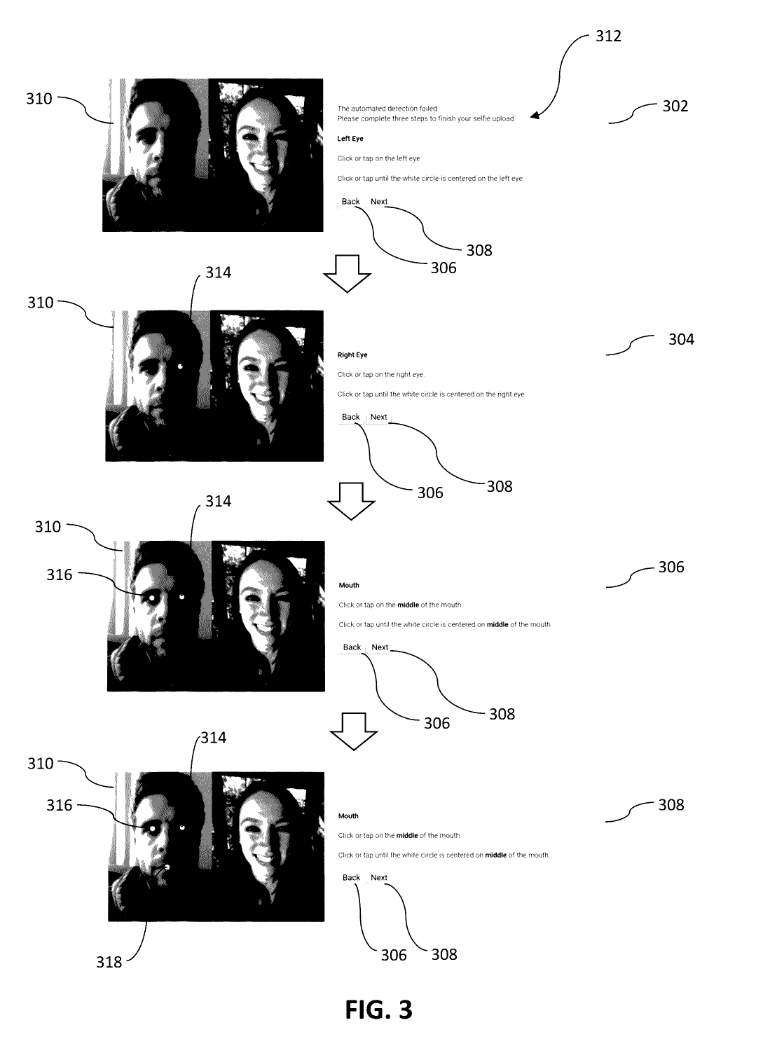

An example of a process is shown in FIG. 3, which depicts a series of windows which may be displayed on a user's screen. The first window 302 includes instructions 312 to the user, directing the user to identify a first facial feature, in this case the left eye, by taping or clicking on the appropriate location in the displayed image 310. In this example, the displayed image 310 includes two faces and therefore automatic detection of the facial features the system was not successful and the system requests manual input. After the user has indicated the left eye, the location indicated by the user is distinguish with a mark to show the user the indicated location on the image 310. If the user is satisfied that the facial feature has been correctly marked, the user may click the “next” button 308 to proceed. In the next window 304, the mark 314 can be seen on the left eye and the instructions 312 now direct the user to identify the second facial feature, in this case the right eye. In the next window 306, after the user has identified the right eye and clicked the “next” button 308, the location of the right eye is distinguished with a mark 316 and the instructions 312 now tell the user to identify the middle of the mouth. In window 308, the user has identified each of the facial features which are shown by marks 314, 316 and 318. In each window, the user has the option to proceed if satisfied with the locations of the marks by pushing the “next” button 308 or to go back to a previous window by pushing the “back” button 306.

In some embodiments, it may be useful for the system to use three facial features which are not located in a line relative to each other. Furthermore, two of the features may be horizontally aligned with each other, such as the left and right eye, and the third may be located in the vertical midline of the face portion, such as the mouth. In this way, the relative positions of the features in the image can be used by the system to determine not only the proper alignment of the face portion within the target space but also to modify the face portion if needed. This alignment may be performed in various ways, such as by using two features, such as the two eyes, or three features, such as both eyes and the mouth. For example, if two of the predefined features are normally located along the same horizontal line on a face, but they are vertically offset in the image, the system may rotate the image clockwise or counterclockwise to place the features into horizontal alignment. In this way, these features may be used to provide vertical alignment of the face portion within the target space as well as to detect and correct rotation. The feature that is located in the vertical midline of the face, such as the mouth, may be used to align the coordinate location of the feature in the image with the target location in the target space, thereby providing horizontal alignment of the face portion. Furthermore, the combination of two or three features may be used to enlarge or reduce the size of the face portion of the image (scale the face portion) by aligning the coordinates of the features with the target locations in the target space.

Once the system has received the identification of the facial features in the image from the user in step 218, or once the system has analyzed and automatically identified the features in step 212, the system identifies the locations of each of the facial features in step 220. Alternatively, the step 220 of identifying the location of the features may occur simultaneously with the steps of manually or automatically identifying the features. Any system of specifically locating a point within a digital image may be used. For example, software may analyze the image using a horizontal and vertical (x, y) coordinate system, which may begin at 0,0 in one corner of the image, such as the upper left corner. The locations of each of the facial features may then be identified as the horizontal and vertical coordinates of the identified features.

Once the locations of the facial features have been identified, the system may identify the face portion of the image in step 222. Depending upon the particular facial features used as the set of facial features in a particular embodiment, the face portion may be identified as a specific area of the image surrounding the features. For example, when the eyes and mouth are used as the set of facial features, the face portion may extend a particular relative distance around the eyes and mouth (relative to the spacing of the eyes and mouth). Alternatively, the facial recognition software of the system may recognize the margins of the face, such as the hairline, chin, ears, or the side or top edge of the head as depicted in the image, and may identify the face portion accordingly using a set of features.

In step 224, the locations of the facial features in the image are compared to the corresponding target locations in the target space to determine if the facial features will align with the target locations when the face portion is inserted into the target space. If the facial features and the corresponding target locations will not align, the system may proceed to modify the face portion of the image in one or more ways as needed to bring the facial features and the corresponding target locations into alignment once the face portion is inserted into the target location.

In step 226, the system may scale the face portion of the image (make it larger or smaller) to bring the facial features into alignment with the target locations in the target space. For example, if the eyes are included in the set of facial features, and they are closer together than the target locations for the eyes in the target space, the image scale may be increased until the locations are aligned. In contrast, if the eyes are too far apart as compared to the target locations of the eyes, the image scale may be decreased to achieve alignment. In step 227, the system may rotate the image to conform with the target location by aligning with the facial features with the corresponding target locations.

In step 228, the face portion of the image may be modified by stretching and/or shrinking/compressing portions of the face portion to bring the facial features into alignment with the target locations in preparation for inserting the face portion into the target space. For example, once the face portion of the image is scaled in step 226 and rotated in step 227, some of the facial features may align with the target locations while others may not. For example, in an embodiment in which the facial features are the eyes and mouth, the image locations of the eyes may align with the target locations for the eyes after scaling the image larger or smaller, but the image feature location of the mouth may be too high or too low relative to the target location of the mouth. If the image feature location of the mouth is too high, the face portion of the image may be stretched along the y-axis to lower the location of the mouth into alignment with the target location of the mouth. Conversely, if the image location of the mouth is too low, the face portion of the image may be shrunk/compressed along the y-axis to raise the mouth into alignment with the target location of the mouth. Such stretching or shrinking/compressing may include stretching or shrinking/compressing of the entire face portion of the image in one direction. For example, the entire face portion may be uniformly stretched or shrunk/compressed, such as in the vertical (y-axis) direction, to lengthen or shorten the face, or in the horizontal direction (x-axis) direction, to widen or narrow the face. Alternatively, only a portion of the face portion of the image may be stretched or shrunk/compressed to bring the facial feature into alignment with the target location, such as the portion of the image adjacent to the facial feature needing alignment.

While the system may be configured to modify the image in various ways to achieve the appropriate alignment, the actual steps performed will vary depending upon the digital image selected by the user. Depending upon the selected picture, all of steps 226, 227 and 228 may be necessary, or only one or two of the steps 226, 227, and 228, or possibly none of the steps 226, 227, 228 may be necessary. Furthermore these steps may be performed in any order. For example, the image could first be scaled to the appropriate magnification and then it may be rotated. Alternatively, it may be rotated first and then scaled. Furthermore, any points in the image, such as any two or more points, may be used as the facial features for the alignment.

In step 230, after the image has been modified such that the facial features will align with the target locations when the face portion is printed in the target space, the face portion can further be modified by cropping it to fit within the margins of the target space. The face portion of the image now will fit within the target space, with each of the facial features of the set aligned with the corresponding target locations. In other embodiments, the facial portion may not be cropped and the portion of the image outside of the target space may be printed outside of the target space such as extending around the target space. If the surface on which the image is printed includes graphics or other colors such as dark colors, these colors and/or graphics may obscure the portion of the image which extends outside of the target space making it less noticeable or unnoticeable.

In step 232, a virtual representation of the face portion of the image inserted into the target space may be presented to the user on a screen such as display 118. The virtual representation may be an image of the face portion, as modified, present within the target space. The virtual representation may also include other elements which would be present on the surface onto which the face portion is to be printed, such as associated printed elements such as the head and or body of a figure. In some embodiments, the virtual representation may be an image of the face portion, as modified, after insertion into a figure. The virtual representation may further depict such figure after assembly, such as after assembly into a three dimensional folded configuration.

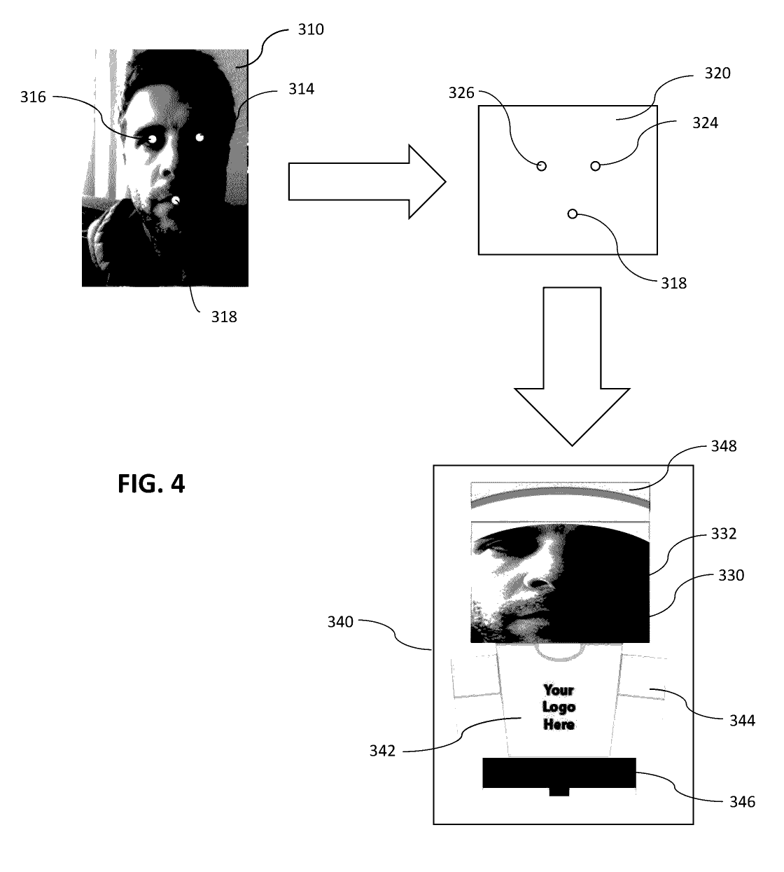

FIG. 4 shows an example of a process of aligning a set of facial features of a digital image with target locations in a target space and presenting a virtual representation to a user. In the image 310, the facial features have been identified and are indicated by the left eye marker 314, right eye marker 316, and mouth marker 318. The locations of these features are then aligned with the corresponding target locations for the left eye 324, right eye 326, and mouth 318 in the target space by fitting the image through scaling and stretching or shrinking/compressing and/or cropping and/or rotating as needed. Once the image 310 is modified to fit into the target space 320 with the facial features 314, 316, 318 aligned with the corresponding target locations 324, 326, 318, a virtual representation 340 of the face within the target space may be sent to the user for the user to observe on a display. In this example, the virtual representation 340 includes an image of a figure which includes the modified face portion 330 as the face 332 of the figure, as well as the figure body 342, arms 344, feet 346, and hat 348. In this way, the user can observe how the face portion 330 will look when printed onto the surface and confirm the accuracy of the system in aligning the face portion 330 within the target space 320, such as prior to ordering and/or submitting payment for a copy of the printed face portion within the target space 320 or a digital file of the same.

In some embodiments, the user may be able to input further modifications to individualize the figure, and these may be received by the system and displayed accordingly in the virtual representation 340. For example, the system may direct the user to identify the type of figure (e.g. type of athlete, type of profession, etc., or type of nonhuman figure such as animal) and may display the figure in the corresponding correct type of clothing or uniform or correct type of animal body. The system may further direct the user to select coloration of the figure, such as one or more colors of the clothing, uniform, animal fur, hair, and/or skin color, and these selections may be received by the system and displayed for the user in the virtual representation. Other modifications may include alphanumeric input, such as the name of the individual in the digital image, a team name, or a number as in a jersey number, which may be displayed on the clothing on the torso (such as the shirt or jersey) or elsewhere, for example.

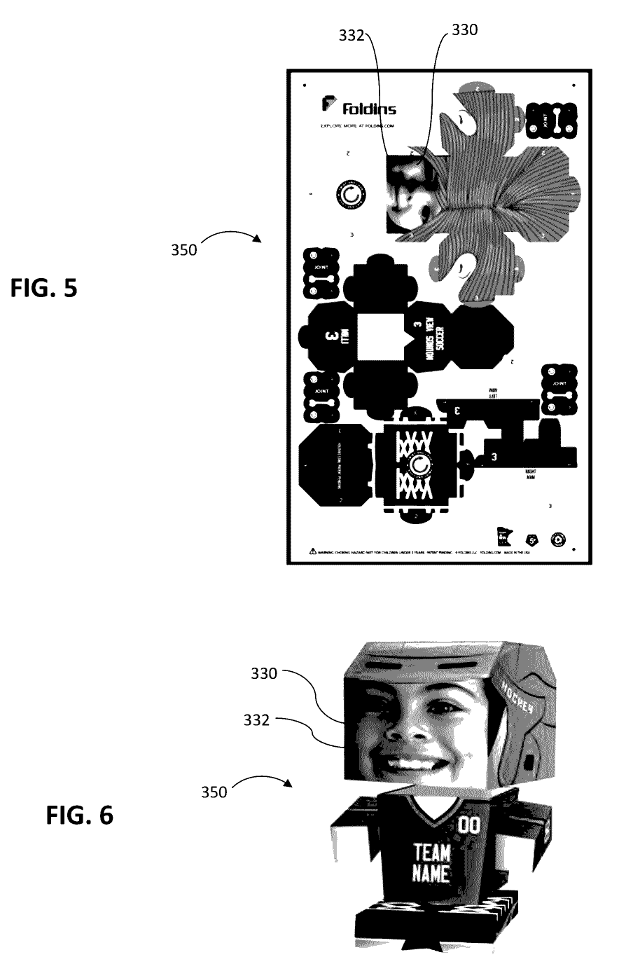

In some embodiments, the user may order and/or submit confirmation or payment for a printed version of the person or portion of the person within a target space. The system may receive this order and/or confirmation or payment and send the digital file to a printer or printing service such as printing service 130 for printing the person or portion of the person in a target space on a surface, and this printed copy may then be delivered to the user such as through a traditional mail service like the U.S. postal service. In some embodiments, the face portion may be a face of a figure as described in U.S. Pat. No. 9,339,735. The printed face portion may be sent to the user along with the body portions of the figure as one or more sheets, from which the body portions and face portion may be separated and folded into a three dimensional figure. An example of such a sheet is shown in FIG. 5, while an example of such a folded three dimensional figure is shown in FIG. 6. The sheet in FIG. 5 shows the face portion 330 of the image included in the target space as the face 332 of the FIG. 350. The sheet also includes various body portions and connectors which may be assembled into a three dimensional figure. In FIG. 6, the components have been assembled into a three dimensional figure, with the face portion 330 of an individual of the selected in the place of the face 332 of the FIG. 350.

In other embodiments, the system may simply send the user a digital file of the person's image or partial image within the target space, including any other associated elements such as a figure body and connector components. The user may print this digital file himself of herself at home using a home printer such as printer 120 or an outside printer to which the user may connect via the internet 124 and/or the user may send the digital file to others for them to see and or print themselves.

The process shown in FIG. 2 and the examples described above in FIGS. 3-6 incorporate a partial image which is a face portion into a target space. However, it should be understood that the same process may be used with different parts of the body as partial images or with the entire body as the person's image. In such cases, the image may be analyzed for body features other than facial features, or for other body features in addition to facial features. The body features used for identifying the person's image or partial image and aligning it with the target space will depend upon what part of the body is being extracted from the image and incorporated into the target space. For example, if the whole body is being incorporated into the target space, the body features may include one or more facial features as described previously, the corner of the shoulders, elbows, hands, knees, feet, hips, etc. If the partial image is, for example, the entire head, the body features might be facial features such as eyes, eyebrows, ears, nose, hairline, chin, etc., or any specific part of these features such as one or more corners of the mouth or eyes, one or more ends of the eyebrows, etc. The steps of the process could proceed as shown in FIG. 2, with the system receiving a selected image, analyzing the image for body features, and either automatically identifying the body features or requesting user input, to identify the person's image or partial image within the digital image. The locations of the body features may be compared to target locations for such features in a target space, and the person's image or partial image may modified (by scaling, rotating and/or stretching or shrinking/compressing) to align the body locations with the target locations. The person's image or partial image may be cropped to fit the target location, and a display of the modified and cropped person's image or partial image within the target space may be presented to the user.

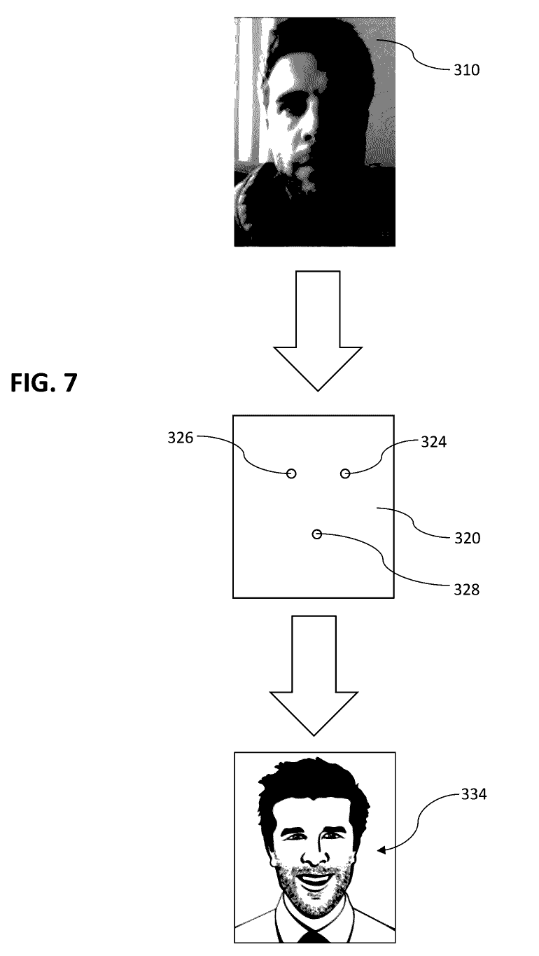

In some embodiments, rather than incorporate the person's actual image or partial image into the target space, the system may first modify the person's image or image portion to create a cartoon or alternative representation version of the person's image or partial image. An example of such an embodiment is shown in FIG. 7, in which a partial image is used which is the person's face. The predefined features of the digital image 310 are aligned with target locations 324, 326, 328 in the target space as described previously. However, in this example, the system further modifies the image to create a cartoon equivalent 334 of the face for use as the face portion. The system may make this alternative representation in many ways such as utilizing identified facial features to inform a program to draw certain facial features such as eyes, nose, mouth, etc. The facial features could also be used to manipulate and adjust an already created face by adjusting certain features on the pre-made graphic face. Another method for producing alternative representations of the digital image is to utilize graphic filters, such as are found in Adobe Photoshop or open source graphic packages, to change the appearance of the digital image.

The above embodiments describe systems which may automatically detect and modify an image of a person in a digital image, but in alternatively embodiments the process of fitting an image of a person or a portion of a person into a target space may be performed manually by a user. For example, the system may receive a selected digital image from a user. The system may further receive a selection of a figure with which the image may be used. For example, the figure may be a human or humanoid figure, such as those described in the incorporated patent applications, and the target space may be the face. The user may manually align the selected image with the figure such as by “dragging” (such as by using a mouse to click and move the image on the user's screen) a virtual representation of the image onto a virtual representation of the figure to position the image of the person or portion of the person in the desired alignment within the target space. The system may then display a virtual representation of selected image of the person or portion of the person such as the face in a target space of the figure as a composite image of the selected image in the target space of the figure. The user may then further modify the image or image portion within the target space such as by dragging to realign the image, stretching and or shrinking/compressing, rotating, shifting, and/or cropping the image manually, such as by using a mouse to interactive with the virtual image on the user's screen. For example, this may be done by clicking on the corner of the image as presented on the screen to control the manipulation. As the user performs these manipulations, the system may display the modified digital image in the target space. Further modifications to the figure, such as color selections as described above, may also be made. The user may continue to make modifications until a final composite virtual image is created with the digital image of the person or portion of the person within the target space of the figure as desired by the user. The final figure may then be printed or a digital file may be sent to the user as described above.

In the foregoing description, the inventions have been described with reference to specific embodiments. However, it may be understood that various modifications and changes may be made without departing from the scope of the inventions.

1. A method of incorporating an image of a person or a portion of a person from a digital image into a target space for printing on a surface comprising:
receiving a selected digital image from a user;
automatically identifying a set of specific body features in the digital image;
modifying the digital image to align locations of the body features in the digital image with corresponding target locations in the target space;
sending a representation of the modified digital image of the person or portion of the person within the target space to the user.

2. The method of claim 1 further comprising:
following the step of automatically identifying the set of specific body features, if one or more of the body features of the set cannot be automatically identified, sending a request to the user to identify the location in the digital image of the one or more body features of the set which could not be automatically identified; and
receiving the location of the one of more body features identified by the user.

3. The method of claim 1 wherein modifying the digital image comprises stretching or shrinking the portion of the digital image which is the image of the person or the portion of the person.

4. The method of claim 1 wherein modifying the digital image comprises cropping the portion of the digital image which is the image of the person or the portion of the person to fit within the target space.

5. The method of claim 1 where in modifying the digital image comprises of rotating the portion of the digital image which is the image of the person or the portion of the person.

6. The method of claim 1 wherein modifying the digital image comprises scaling by either stretching or shrinking, cropping, and rotating the portion of the digital image that is the image of the person or portion of the person so that the image of the person or portion of the person is configured to fit within, and is aligned within, the target space when printed.

7. The method of claim 1 wherein the set of body features comprises 3 facial features.

8. The method of claim 7 wherein the set of facial features comprises the two eyes and mouth of a person captured in the digital image.

9. The method of claim 1 wherein the target space comprises a face portion of a figure.

10. The method of claim 1 further comprising printing the modified image of the person or portion of the person on the surface in the target space.

11. The method of claim 1 wherein the image of the person or portion of the person is a face portion, further comprising printing the face portion and a body portion of a figure, wherein the face portion in the target space forms the face of the figure.

12. The method of claim 11 wherein printing the face portion and the body portion of the figure comprises printing on a sheet, wherein the figure is configured to be separated from a portion of the sheet surrounding the figure and folded into a 3 dimensional shape.

13. A method of incorporating a face portion of a digital image into a target space for printing on a surface comprising:
receiving a selected digital image from a user;
automatically identifying a set of specific facial features in the digital image;
modifying the digital image to align locations of the facial features of the digital image with corresponding target locations in the target space;
sending a virtual image of the face portion of the modified digital image within the target space to the user.

14. The method of claim 13 further comprising:
sending a digital file of the face portion of the modified digital image within the target space to a printer to print a physical copy of the face portion the in the target space; and
sending the printed physical copy of the face portion in the target space to an address provided by a user.

15. The method of claim 16 further comprising receiving a color selection for an aspect of the figure from the user; wherein the virtual image includes the selected portion displayed as an aspect of the figure.

16. The method of claim 17 wherein the aspect of the figure comprises a skin color, and wherein the method further includes providing a graphical user interface including an array of skin colors enabling the user to select the skin color.

17. The method of claim 17 wherein the aspect of the figure comprises a color of clothing on the figure, and wherein the method further includes providing a graphical user interface including an array of colors enabling the user to select the clothing color.

18. A method of creating a folded figure incorporating an image of a person or a portion of a person from a digital image into a target space on the figure comprising:
receiving a selected digital image from a user;
displaying a representation of the image of the person or the portion of the person in a target space of the figure;
receiving input from the user modifying the digital image in the target space;
displaying a representation of the modified digital image in the target space of the figure.

19. The method of claim 18 wherein the input from the user modifying the digital image comprises one or more of aligning the image of the person or portion of the person with the target space, rotating the digital image, or stretching or shrinking the digital image.

20. The method of claim 18 further comprising:
sending a digital file of the modified digital image within the target space to a printer to print a physical copy of the figure on a foldable sheet; and
sending the printed physical copy of the figure to an address provided by a user.
